(19) United States
(12) Patent Application Publication
(10) Pub. No.: US 2015/0156597 A1
(43) Pub. Date: Jun. 4, 2015

(54) METHOD AND SYSTEM FOR PREDICTING HUMAN ACTIVITY

(71) Applicant: Stichting INCAS3, Assen (NL)

(72) Inventors: Matthew Lee COLER-THAYER, Amsterdam (NL); Heinrich Johannes WÖRTCHE, Bedum (NL)

(21) Appl. No.: 14/557,199

(22) Filed: Dec. 1, 2014

(30) Foreign Application Priority Data
Dec. 4, 2013 (NL) 2011893

(51) Int. Cl. H04R 29/00

(52) U.S. Cl. CPC H04R 29/00

(57) ABSTRACT

Some embodiments are directed to a method of predicting which type(s) of human activity is/are to be expected in a certain geographical area or location. A human activity type for each of a first set of locations is determined. At a first set of locations, sounds are recorded, and for each of the first set of locations, an acoustic signature is determined. To each of the determined acoustic signatures, a human activity is linked. After this initialisation step(s), sounds are recorded at a second set of locations, and for each of the second set of locations, an acoustic signature is determined. Finally, a human activity type for each of the second set of locations is predicted by matching the acoustic signatures of the locations of the second set with acoustic signatures of the location of the first set.

### FIELD

Some embodiments relate to the field of human activity studies, acoustics, machine learning, and urban planning, and more specifically to techniques of predicting human activities.

### BACKGROUND ART

In order to be able to (re)design and improve urban environments, urban planners may combine GIS data with data gathered with surveys and questionnaires. However, these methods are insufficient for adequately characterizing the acoustic environment. Characterizing impressions of the acoustic environment is important for urban planners because the acoustic environment correlates to quality of life, psychological well-being and physical health. The acoustic environment also determines how a place is used by people, and if a place is used as it was intended.

### SUMMARY

As urban planners could more effectively (re)design and improve urban environments using information about how people perceive and use different acoustic environments, there is a need for a method and system to meaningfully characterize different acoustic environments and, based on that characterization, predict human activity in that same environment.

Some embodiments provide a method of predicting which type(s) of human activity is/are to be expected in a certain geographical area or location. This method can include:
determining different types of human activities for different groups of humans for each of a first set of locations;
recording sounds at said first set of locations to obtain sound recordings;
determining an acoustic signature from the sound recordings for each of the first set of locations;
linking a human activity to each of the determined acoustic signatures;
recording sounds at a second set of locations;
determining an acoustic signature for each of the second set of locations; and
determining a human activity type for each of the second set of locations, by matching the acoustic signatures of the locations of the second set with signatures of the location of the first set.

An embodiment can further include recalculating an acoustic signature associated with a location of the first set of locations using recorded sound information of a location of the second set of locations for which the acoustic signature matched the acoustic signature of the location of the first set of locations.

In an embodiment, the determining a human activity type for each of the first set of locations includes collecting fieldwork data.

In an embodiment, the recording sounds at the first and second set of locations is performed using a distributed network of sound recorders.

In an embodiment, the acoustic signature is produced using a spectrogram. The acoustic signature can include at least one of the following:
a minimum value of a spectrogram,
a maximum value of the spectrogram;
a mean value of the spectrogram; and
a ratio of total energy in a relative high frequency band and a total energy in a relative low frequency band.

In an embodiment, the acoustic signature is determined for each of the first set of locations for multiple moments in time depending on the amount and type of variation. In an embodiment, the method further includes:
receiving user input, the input including an identifier of a requested geographical area or location; and
outputting one or more types of human activity to be expected in the requested geographical area or location based on said determined human activity types for said first set of locations.

In an embodiment, GIS data is used for the outputting of the one or more types of human activity.

In a further embodiment, data from a social media network is used for the outputting of the one or more types of human activity.

In yet a further embodiment, a geographical map is produced showing a representation of the one or more types of human activity to be expected in the requested geographical area or location. The geographical map may be produced using a graphical user interface.

In an embodiment, the acoustic signature of a particular location is linked to a number of possible human activities with their associated probability rate based on the degree of similarity between the acoustic signature for the particular location and the acoustic signatures associated with certain human activities.

In an embodiment, the one or more types of human activity is subdivided in human activity performed by a specific group of humans characterized by one or more of gender, goal, knowledge, or sociocultural particularity.

According to a further aspect, there is provided a system for predicting which type(s) of human activity is/are to be expected in a certain geographical area or location. The system can include:
a first plurality of sound recorders for recording sounds at a first set of locations;
a second plurality of sound recorders for recording sounds at a second set of locations; and
a processing module arranged for:
   receiving sound data from the first plurality of sound recorders;
   determining an acoustic signature for each of the first set of locations;
   determining different types of human activity type for different groups of humans for each of the first set of locations;
   linking a human activity to each of the determined acoustic signatures;
   receiving sound data from the second plurality of sound recorders;
   determining an acoustic signature for each of the second set of locations; and
   determining a human activity type for each of the second set of locations, by matching the acoustic signatures of the locations of the second set with signatures of the location of the first set.

These and other aspects will be apparent from and elucidated with reference to the embodiments described hereinafter.

### BRIEF DESCRIPTION OF THE DRAWINGS

Further details, aspects and embodiments will be described, by way of example only, with reference to the drawings. Elements in the figures are illustrated for simplicity and clarity and have not necessarily been drawn to scale.

FIG. 1 schematically shows a system according to an embodiment; and

FIG. 2 schematically shows a flow chart of a method according to an embodiment.

Elements in the figures are illustrated for simplicity and clarity and have not necessarily been drawn to scale. In the Figures, elements which correspond to elements already described may have the same reference numerals.

### DETAILED DESCRIPTION OF THE PREFERRED EMBODIMENTS

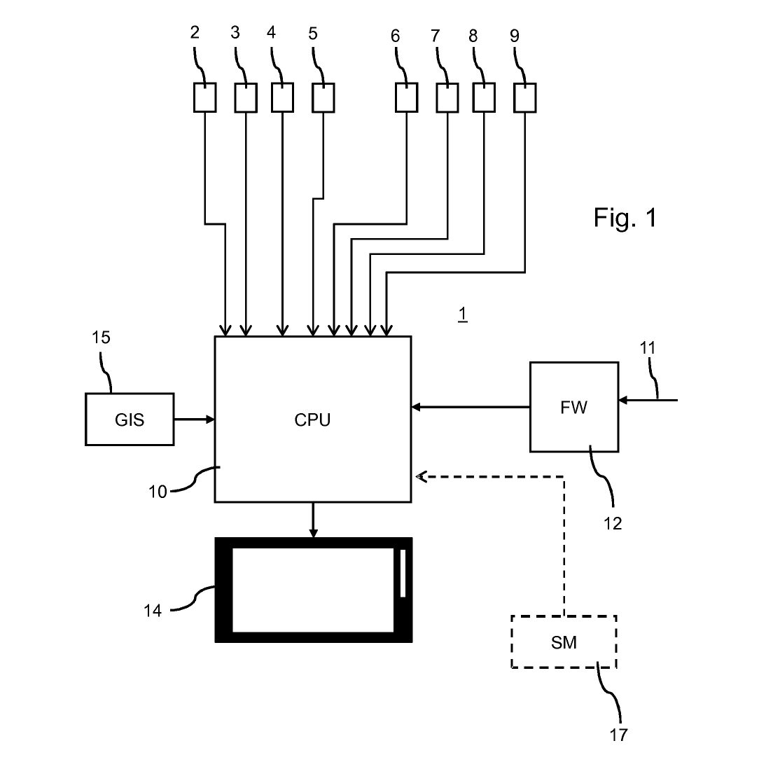

FIG. 1 schematically shows an embodiment of a system 1 for predicting which type(s) of human activity is/are to be expected in a certain geographical area or location. The system 1 includes a first plurality of sound recorders 2,3,4,5 for recording sounds at a first set of locations. A second plurality of sound recorders 6,7,8,9 is arranged for recording sounds at a second set of locations. The sound recorders of the first and second set could all be separate recording units put on different locations distributed in an area of interest for which predictions are wanted. The system 1 also includes a processing module 10 arranged for receiving sound data from the first and second set of sound recorders. The processing module 10 could be a computer having memory and one or more processors to execute instruction in order to perform specific tasks. Alternatively, the processing module 10 could include several processing units communicating with each other so as to perform the specific tasks. The processing module 10 is arranged to determine an acoustic signature for each of the first set of locations. An acoustic signature comprises one or more features of recorded sound data. Possible features could be a minimum or maximum value of a cochleogram, a mean value of the spectrogram, or a ratio of a total energy in a relatively high frequency band versus a total energy in a relatively low frequency band. Instead of spectrograms, other type of data could be used such as cochleograms, which are specific spectrograms modeled by using a cochlea model.

In an embodiment, one or more human activity types are determined for each of the first set of locations. The human activities can be determined by way of fieldworkers registering human activity at the locations. The activities could be entered by the fieldworker in separate mobile units communicating directly or afterwards, see arrow 11, with a database 12 for storing the fieldwork data. In this way relevant activity data is available for these locations. The activities could be registered for different moments of the day, different days of the week, or any other time frequency relevant for human activity predictions used e.g. by urban planners, municipalities or governments.

The processing module 10 is arranged to link a human activity to each of the determined acoustic signatures. Thus, once at a location L1 a certain activity at a certain time is registered, it can be linked to a measured acoustic signature for that location and recording time. By linking these data, acoustic signatures will obtain a meaning for the processing module 10.

Now, the processing module 10 can receive sound data from the second plurality of sound recorders 6,7,8,9, and also determine an acoustic signature for each of these locations. Once the acoustic signatures at the locations 6,7,8,9, are determined, they can be matched with known acoustic signatures, which were linked to one or more specific human activity types. By matching the acoustic signatures of the locations of the second set with signatures of the location of the first set, a human activity type for each of the second set of locations can be determined. This is further explained by way of a simple example.

In this example, one or more sound recorders gather a set of recordings from three locations L1,L2,L3. Next, an (initial) acoustic signature is determined for each of the locations. This may involve choosing a certain feature representation for the recordings, e.g., min and max value of the cochleogram, mean value of the cochleogram, ratio energy-in-high-frequencies versus energy-in-low-frequencies. Some sort of feature selection may be performed to find features that are relevant for distinguishing different locations. For the relevant features a mean and standard deviation of the feature values may be calculated for each location. This would result in the initial acoustic signatures. Thus, in this example:
relevant features turn out to be: minimum value of the cochleogram and ratio high/low.
location L1: min=8 dB +/−2 dB; high/low ratio=2.3+/−0.4
location L2: min=50 dB +/−10 dB; h/l ratio=0.3+/−0.01
location L3: min=40 dB +/−4 dB; h/l ratio=1.1+/−0.6

Now, it can be determined, for any new recording at a location L4, the location to which it is most similar. This can be performed by calculating the same features for the new recordings. Suppose that for a new recording min=20 dB, high/low ratio=1.2. This signature is most similar to the signature of location L3, and thus it is expected that the sound environment at the L4 is like location L3. Thus, we would expect the activities at L4 to be like those occurring at location L3 at that specific time.

Due to the recalculation of the acoustic signatures while the system is running, it can refine the acoustic signature if new recordings come in and are assigned to be ‘most like location 3’, then the values of location 3 (40+/−4; 1.1+/−0.6) can be re-calculated taking the values of the new recording into account as well.

The recording of sounds at the first and second set of locations may be performed using a distributed network of sound recorders. The distributed network may include several installed recording units arranged to communicate with a central server and/or the processing module 10. Communication may be realized by wired or wireless networks, or combinations of those types. Each of the recording units may include microphones and processing equipment arranged to process sound recordings by way of e.g., producing spectrograms or cochleograms or any other type of suitable processing. The recording units may also be arranged so as to determine the acoustic signatures.

In the embodiment of FIG. 1, the system 1 also includes an I/O module 14 which may include a personal computer, a display and/or separate input device (not shown). It may also be a type of I/O module, such as a touch screen of a tablet or smart phone. The I/O module may also include a printer or printing device for outputting data on paper.

The I/O module 14 is arranged to communicate with the processing module 10 and to receive user input from a user. The input may include an identifier of a requested geographical area or location. The entered identifier may then be sent to the processing module 10 to produce predictions for the requested area or location. The I/O module may further be arranged to output one or more types of human activity to be expected in the requested geographical area or location. The outputting may be executed using GIS data received from a GIS data storage 15 in communication with the processing module 10 or with the I/O module 14. A geographical map may be produced showing a representation of the one or more types of human activity to be expected in the requested geographical area or location. This may be realized using a GUI arranged to display geographical information on human activity information.

In an embodiment, the processing module 10 may also use social media information received from or via a social media network 17, see FIG. 1. Social media information can be combined with fieldwork data and/or recorded sound data to enhance the activity information used to do the predictions.

The acoustic signature may be linked to a number of possible human activities with their associated probability rate. Thus, for example, an acoustic signature for location L1 in a city centre may be linked to the activity ‘Shopping activity’ having a probability of 70%, and to the activity ‘Loitering’ having a probability of 30%. Once a similar acoustic signature is recorded at another location not yet linked to an activity, the prediction can be made that at that other location there is a 70% chance that people are shopping.

In an embodiment, the human activity is subdivided in human activity performed by a specific group of humans. The groups could be characterized using the following features: the gender, the goal, the knowledge, or sociocultural particularity of certain humans.

In the system and method described above, machine learning techniques could be used. Most notably, these techniques can be used to automatically learn the acoustic signature from a dataset of recordings, or to continually update and refine the acoustic signature during deployment. Learning algorithms, e.g., Bayesian models, clustering, semi-supervised learning, or support vector machines, could be used to enhance or optimize the performance of the predicting system.

In an embodiment, signatures are classified on the basis of human activity type/s, possibly uniquely on that basis. Rather than using signatures to recognize acoustic events like traffic, footsteps, or shouts, signatures categorise types of acoustic environments. In an embodiment of the method of predicting human activity types, accessory devices, such as accelerometers and/or pyroelectric detectors, are not used.

In an embodiment, the method forms an acoustic environment detector that predicts human activity. An embodiment of the method may include the following steps: determining locations in which a pre-determined set of human activities is likely to occur. For example, in parks recreational activities are likely to occur. Sound is recorded at the determined locations to obtain sound recordings. From the sound recording, an acoustic signature is determined, e.g., calculated. A further set of locations is determined in which the pre-determined set of human activities is not likely to occur. For example, in industrial areas, or highways, etc., recreational activities are not likely to occur. Sound recordings are obtained from the further set of locations, and it is confirmed that the sound recordings, or at least a pre-determined part thereof, such as a percentage, such as 75%, do not match the signature obtained from the recordings at the first set of locations. If the latter test is passed, the signature may be used to detect recreational activity; if not more recordings from the first set of locations may be obtained to refine the signature.

The set of locations where certain activities are likely to be performed may be obtained, e.g., from city zoning plans.

The acoustic signature may, but need not, be generated by using a bag-of-frames approach, according to which the components of the acoustic environment are not the object of study, but rather focus is on the statistical distribution of a set of temporal or spectral features including Mel-frequency Cepstral Coefficients (MFCCs), typically crucial for distinguishing harmonic sounds. This approach can be augmented with reference to specific spectro-temporal characteristics, like signal components with the same onset and offset, a similar development or arriving from a common direction, and thus may be said to likely be produced by the same source or sources. Knowledge of probable sources will permit use of auditory stream analysis techniques, like those used for computational auditory scene analysis according to which sounds can be automatically separated in a way that is purported to be analogous to that performed by the mechanisms of the human auditory system. The physical description of this signature is used as the basis on which to classify and label recordings with particular machine learning techniques.

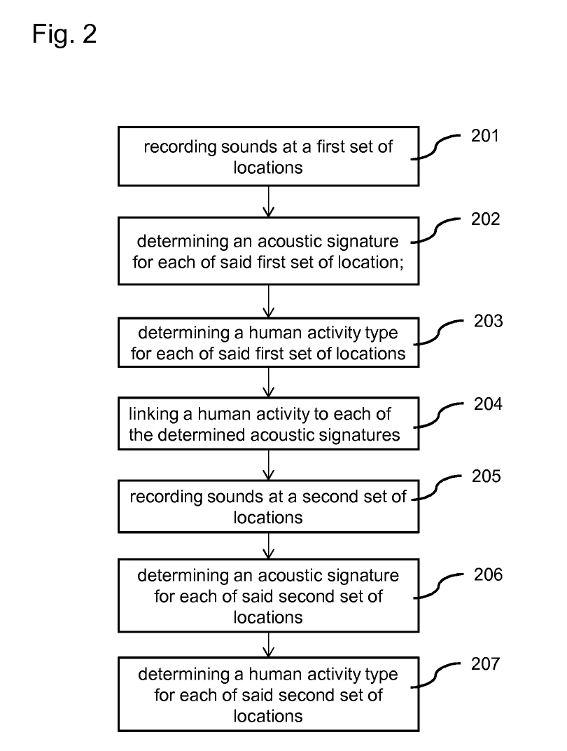

FIG. 2 schematically shows a flow chart of a prediction method according to an embodiment. In a first step 201, sounds are recorded at a first set of locations. Next, in a step 202, an acoustic signature is determined for each of the first set of locations. In a step 203 a human activity type is determined for each of the first set of locations. Then, in a step 204, linking is performed of a human activity to each of the determined acoustic signatures.

After the initialisation phase that includes the steps 201-204, sounds are recorded at a second set of locations, see step 205. These locations could partly overlap with the location used at the initialisation phase. In step 206, an acoustic signature is determined for each of the second set of locations. Finally, a human activity type is determined for each of the second set of locations, by matching the acoustic signatures of the locations of the second set with signatures of the location of the first set, see step 207. In an embodiment, determining 203 is performed before recording 201. As was described above, the predicted human activities can be outputted on a screen or in any other possible way convenient for the user.

Embodiments may also be implemented in a computer program for running on a computer system, at least including code portions for performing steps of a method according to an embodiment when run on a programmable apparatus, such as a computer system or enabling a programmable apparatus to perform functions of a device or system according to an embodiment. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system. The computer program may be provided on a data carrier, such as a CD-rom or diskette, stored with data loadable in a memory of a computer system, the data representing the computer program. The data carrier may further be a data connection, such as a telephone cable or a wireless connection.

In the foregoing specification, the invention has been described with reference to specific examples of embodiments of the invention. It will, however, be evident that various modifications and changes may be made therein without departing from the broader spirit and scope of the invention as set forth in the appended claims. For example, the connections may be any type of connection suitable to transfer signals from or to the respective nodes, units or devices, for example via intermediate devices. Accordingly, unless implied or stated otherwise the connections may for example be direct connections or indirect connections.

The term “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

Some of the above embodiments, as applicable, may be implemented using a variety of different information processing systems. For example, although FIG. 1 and the discussion thereof describe an exemplary information processing system, this exemplary architecture is presented merely to provide a useful reference in discussing various aspects of the invention. Of course, the description of the system has been simplified for purposes of discussion, and it is just one of many different types of appropriate systems that may be used in accordance with the invention. Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

All or some of the software described herein may be received elements of the system 1, for example, from computer readable media such as memory or other media on other computer systems. Such computer readable media may be permanently, removably or remotely coupled to an information processing system, such as system 1. The computer readable media may include, for example and without limitation, any number of the following: magnetic storage media including disk and tape storage media; optical storage media such as compact disk media (e.g., CDROM, CDR, etc.) and digital video disk storage media; non-volatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

In one embodiment, the processing module 10 is a computer system, such as a personal computer system. Other embodiments may include different types of computer systems. Computer systems are information handling systems which can be designed to give independent computing power to one or more users. Computer systems may be found in many forms including but not limited to mainframes, minicomputers, servers, workstations, personal computers, notepads, personal digital assistants, electronic games, automotive and other embedded systems, cell phones and various other wireless devices. A typical computer system includes at least one processing unit, associated memory and a number of input/output (I/O) devices.

A computer system processes information according to a program and produces resultant output information via I/O devices. A program is a list of instructions, such as a particular application program and/or an operating system. A computer program is typically stored internally on computer readable storage medium or transmitted to the computer system via a computer readable transmission medium. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Also, the invention is not limited to physical devices or units implemented in non-programmable hardware but can also be applied in programmable devices or units able to perform the desired device functions by operating in accordance with suitable program code. Furthermore, the devices may be physically distributed over a number of apparatuses, while functionally operating as a single device.

In the claims, any reference signs placed between parentheses shall not be construed as limiting the claim. The word ‘including’ or ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A method of predicting which type(s) of human activity is/are to be expected in a certain geographical area or location, the method comprising:
determining different types of human activities for different groups of humans for each of a first set of locations;
recording sounds at said first set of locations to obtain sound recordings;
determining an acoustic signature from the sound recordings for each of said first set of locations;
linking a human activity to each of the determined acoustic signatures;
recording sounds at a second set of locations;
determining an acoustic signature for each of said second set of locations; and
determining a human activity type for each of said second set of locations, by matching the acoustic signatures of the locations of the second set with signatures of the location of the first set.

2. The method of predicting according to claim 1, wherein said action of determining different types of human activities for each of said first set of locations comprises collecting fieldwork data.

3. The method of predicting according to claim 1, wherein said recording sounds at said first and second set of locations is performed using a distributed network of sound recorders.

4. The method of prediction according to claim 1, wherein said acoustic signature is produced using a spectrogram, said acoustic signature comprising at least one of the following:
a minimum value of a spectrogram,
a maximum value of said spectrogram;
a mean value of said spectrogram; and
a ratio of total energy in a relative high frequency band and a total energy in a relative low frequency band.

5. The method of predicting according to claim 1, wherein said acoustic signature is determined for each of said first set of locations for multiple moments in time depending on the amount and type of variation.

6. The method of predicting according to claim 1, wherein said method further comprises:
receiving user input, said input comprising an identifier of a requested geographical area or location; and
outputting one or more types of human activity to be expected in said requested geographical area or location based on said determined human activity types for said first set of locations.

7. The method of predicting according to claim 6, wherein GIS data is used for said outputting of said one or more types of human activity.

8. The method of predicting according to claim 6, wherein data from a social media network is used for said outputting of said one or more types of human activity.

9. The method of predicting according to claim 6, wherein said outputting comprises:
producing a geographical map showing a representation of said one or more types of human activity to be expected in said requested geographical area or location.

10. The method of predicting according to claim 9, wherein said geographical map is produced using a graphical user interface.

11. The method of predicting according to claim 1, wherein said acoustic signature is linked to a number of possible human activities with their associated probability rate based on the degree of similarity between the acoustic signature for the particular location and the acoustic signatures associated with certain human activities.

12. The method of predicting according to claim 1, wherein said one or more types of human activity is subdivided in human activity performed by a specific group of humans characterized by one or more of the following:
gender,
goal,
knowledge, and
sociocultural particularity.

13. The method of predicting according to claim 1, further comprising recalculating an acoustic signature associated with a location of the first set of locations using recorded sound information of a location of the second set of locations for which the acoustic signature matched the acoustic signature of the location of the first set of locations.

14. The method of predicting according to claim 1, further comprising recording sounds at a further set of locations to obtain further sound recordings, determining that a sufficient part of the further sound recordings do not agree with the acoustic signature, if an insufficient part of the further sound recordings does not agree with the acoustic signature obtaining additional sound recordings from the first set of locations.

15. A system for predicting which type(s) of human activity is/are to be expected in a certain geographical area or location, the system comprising:
a first plurality of sound recorders for recording sounds at a first set of locations;
a second plurality of sound recorders for recording sounds at a second set of locations; and
a processing module arranged for:
receiving sound data from said first plurality of sound recorders;
determining an acoustic signature for each of said first set of locations;
determining different types of human activity type for different groups of humans for each of said first set of locations;
linking a human activity to each of the determined acoustic signatures;
receiving sound data from said second plurality of sound recorders;
determining an acoustic signature for each of said second set of locations; and
determining a human activity type for each of said second set of locations, by matching the acoustic signatures of the locations of the second set with signatures of the location of the first set.

16. The system as in claim 15, wherein the processing module is further arranged for: recalculating an acoustic signature associated with a location of the first set of locations using recorded sound information of a location of the second set of locations for which the acoustic signature matched the acoustic signature of the location of the first set of locations.
